(19) United States
(12) Patent Application Publication
(10) Pub. No.: US 2010/0138829 A1
(43) Pub. Date: Jun. 3, 2010

(54) Systems and Methods for Optimizing Configuration of a Virtual Machine Running At Least One Process

(76) Inventors: Vincent Hanquez, Cambridge (GB); Jonathan James Ludlam, Cambridgeshire (GB); Richard William Sharp, Cambridgeshire (GB); David Jonathan Scott, Cambridge (GB)

Correspondence Address: CHOATE, HALL & STEWART / CITRIX SYSTEMS, INC., TWO INTERNATIONAL PLACE, BOSTON, MA, 02110, US

(21) Appl. No.: 12/325,713

(22) Filed: Dec. 1, 2008

(51) Int. Cl. G06F 9/455; G06F 12/00

(52) U.S. Cl. 718/1; 711/104; 711/E12.001

(57) ABSTRACT

A system for optimizing configuration of a virtual machine running at least one process includes at least one virtual resource in a virtual machine executing on a computing device, an agent executing within the virtual machine, and a hypervisor. The at least one virtual resource has a configuration parameter. The agent identifies a name of at least one process currently executing on the virtual machine. The hypervisor alters, in response to receiving the identified name from the agent, a value of the configuration parameter.

### FIELD OF THE DISCLOSURE

This disclosure generally relates to systems and methods for optimizing virtual machines. In particular, this disclosure relates to systems and methods for optimizing configuration of a virtual machine running at least one process.

### BACKGROUND OF THE DISCLOSURE

In conventional computing environments implementing a hypervisor to execute a virtual machine on a host computing device, the hypervisor typically provides the virtual machine with access to hardware resources provided by the host computing device. In conventional environments, this process does not re-evaluate the requirements of a virtual machine once the hypervisor has allocated the resources. For example, a typical hypervisor may allocate a number of available physical processors to a number of virtual machines by assigning one processor to each machine, without regard for the requirements of any particular virtual machine or the functionality available from any particular physical processor. In such an environment, should a first virtual machine begin executing a process that requires additional functionality from a physical processor or places excessive load on an allocated physical processor, a conventional system does not typically include functionality for evaluating the needs of the first virtual machine and allocating to the first virtual machine additional physical processors. Since the hypervisor may have allocated additional physical processors to other virtual machines that may not be fully utilizing their allocated physical processors, these conventional systems may result in allocation inefficiencies and underperformance by one or more of the virtual machines on a computing device.

### BRIEF SUMMARY OF THE DISCLOSURE

In one aspect, a method for optimizing configuration of a virtual machine running at least one process includes specifying, by a hypervisor executing on a computing device, a configuration parameter of at least one virtual resource in a virtual machine executing on the computing device. The method includes identifying, by an agent executing in the virtual machine, a name of at least one process currently executing on the virtual machine. The method includes altering, in response to the identification of the name, a value of the specified configuration parameter. In one embodiment, the method includes transmitting, by the agent, the identified name to the hypervisor. In another embodiment, the method includes altering, by the hypervisor, the value of the specified configuration parameter. In still another embodiment, the method includes altering, by the hypervisor, a value of a configuration parameter of at least one virtual resource in a second virtual machine. In yet another embodiment, the method includes allocating, by the hypervisor, access by the at least one virtual resource to at least one physical resource provided by the computing device, responsive to the value of the specified configuration parameter.

In another aspect, a system for optimizing configuration of a virtual machine running at least one process includes a at least one virtual resource in a virtual machine executing on a computing device, an agent executing within the virtual machine and a hypervisor. The at least one virtual resource has a configuration parameter. The agent identifies a name of at least one process currently executing on the virtual machine. The hypervisor alters, in response to receiving the identified name from the agent, a value of the configuration parameter.

In one embodiment, the at least one virtual resource is a virtual processor. In another embodiment, the at least one virtual resource is virtual memory. In still another embodiment, the agent transmits the identified name to the hypervisor. In yet another embodiment, the hypervisor alters a value of a configuration parameter of a virtual resource in a second virtual machine. In some embodiments, the hypervisor executes the virtual machine. In other embodiments, the hypervisor allocates access by the at least one virtual resource to at least one physical resource provided by the computing device, responsive to a value of the specified configuration parameter.

In one embodiment, the hypervisor alters a value specifying an amount of physical processor time allocated to the virtual machine. In another embodiment, the hypervisor alters a value specifying an amount of random access memory (RAM) allocated to a page table associated with the virtual machine. In still another embodiment, the hypervisor alters a value specifying an amount of physical random access memory (RAM) allocated to the virtual machine.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a computing environment comprising a hypervisor layer, a virtualization layer, and a hardware layer;

FIGS. 1B and 1C are block diagrams depicting embodiments of computing devices useful in connection with the methods and systems described herein;

FIG. 2A is a block diagram depicting an embodiment of a system for optimizing configuration of a virtual machine running at least one process;

FIG. 2B is a block diagram depicting an embodiment of a system for optimizing configuration of a plurality of virtual machines; and

FIG. 3 is a flow diagram depicting an embodiment of a method for optimizing configuration of a virtual machine running at least one process.

### DETAILED DESCRIPTION

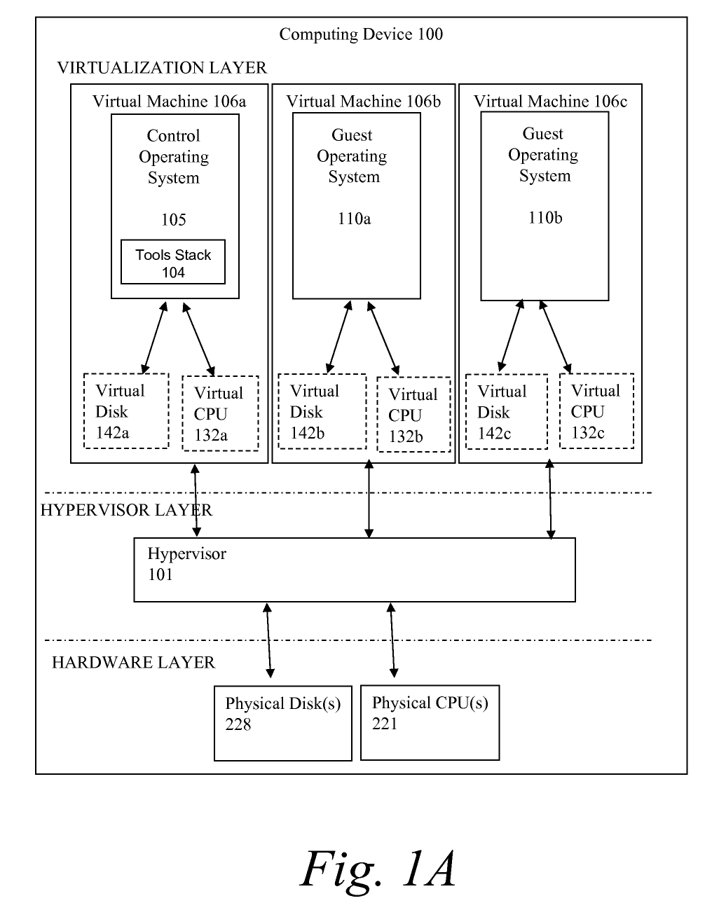

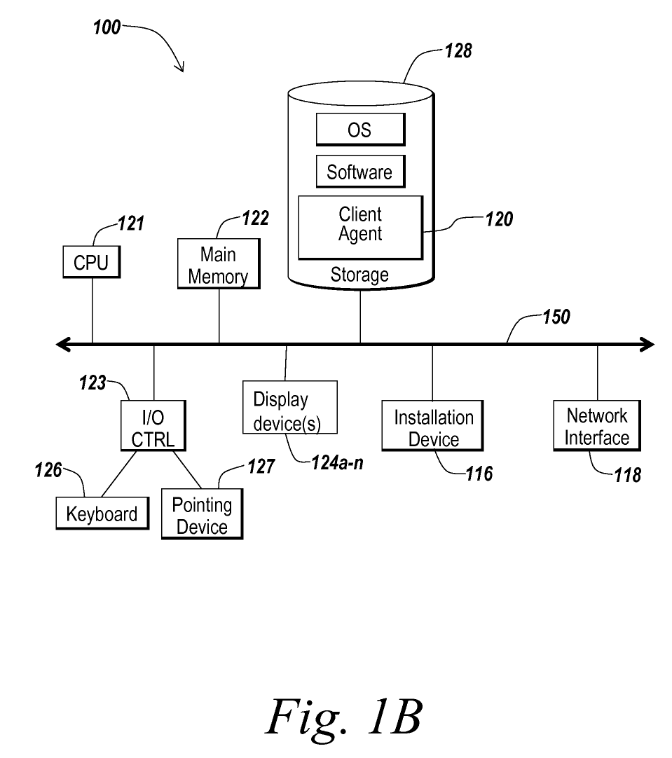

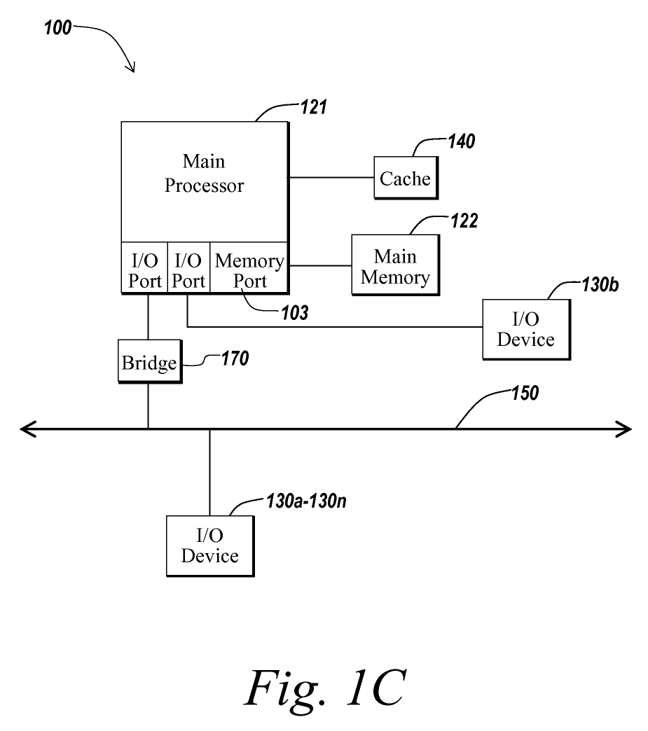

Referring now to FIG. 1A, a block diagram depicts one embodiment of a virtualization environment. In brief overview, a computing device 100 includes a hypervisor layer, a virtualization layer, and a hardware layer. The hypervisor layer includes a hypervisor 101 (also referred to as a virtualization manager) that allocates and manages access to a number of physical resources in the hardware layer (e.g. the processor(s) 221, and disk(s) 228) by at least one operating system executing in the virtualization layer. The virtualization layer includes at least one operating system and a plurality of virtual resources allocated to the at least one operating system, which may include a plurality of virtual processors 132a, 132b, 132c (generally 132), and/or virtual disks 142a, 142b, 142c (generally 142). The plurality of virtual resources and the operating system 110 may be referred to as a virtual machine 106. A virtual machine 106 may include a control operating system 105 in communication with the hypervisor 101 and used to execute applications for managing and configuring other virtual machines on the computing device 100.

Referring now to FIG. 1A, and in greater detail, a hypervisor 101 may provide any virtual resources to an operating system in any manner that simulates the operating system having access to a physical device. A hypervisor 101 may provide virtual resources to any number of guest operating systems 110a, 110b (generally 110). In some embodiments, a computing device 100 executes one or more types of hypervisors rather than operating systems. In these embodiments, hypervisors may be used to emulate virtual hardware, partition physical hardware, virtualize physical hardware, and execute virtual machines that provide access to computing environments. Hypervisors may include those manufactured by VMWare, Inc., of Palo Alto, Calif.; the Xen hypervisor, an open source product whose development is overseen by the open source Xen.org community; HyperV, VirtualServer or virtual PC hypervisors provided by Microsoft or others. In some embodiments, a computing device 100 executing a hypervisor that creates a virtual machine platform on which guest operating systems may execute is referred to as a host server. In one of these embodiments, for example, the computing device 100 is a XEN SERVER provided by Citrix Systems, Inc., of Fort Lauderdale, Fla.

In some embodiments, a hypervisor 101 executes within an operating system executing on a computing device. In one of these embodiments, a computing device executing an operating system and a hypervisor 101 may be said to have a host operating system (the operating system executing on the computing device), and a guest operating system (an operating system executing within a computing resource partition provided by the hypervisor 101). In other embodiments, a hypervisor 101 interacts directly with hardware on a computing device, instead of executing on a host operating system. In one of these embodiments, the hypervisor 101 may be said to be executing on “bare metal,” referring to the hardware comprising the computing device.

In some embodiments, a hypervisor 101 may create a virtual machine 106a-c (generally 106) in which an operating system executes. In one of these embodiments, for example, the hypervisor 101 loads a virtual machine image to create a virtual machine. In another of these embodiments, the hypervisor 101 executes an operating system within the virtual machine. In still another of these embodiments, the virtual machine executes an operating system.

In some embodiments, the hypervisor 101 controls processor scheduling and memory partitioning for a virtual machine 106 executing on the computing device 100. In one of these embodiments, the hypervisor 101 controls the execution of at least one virtual machine 106. In another of these embodiments, the hypervisor 101 presents at least one virtual machine 106 with an abstraction of at least one hardware resource provided by the computing device 100. In other embodiments, the hypervisor 101 controls whether and how physical processor capabilities are presented to the virtual machine 106.

A control operating system 105 may execute at least one application for managing and configuring the guest operating systems. In one embodiment, the control operating system 105 may execute an administrative application, such as an application including a user interface providing administrators with access to functionality for managing the execution of a virtual machine, including functionality for executing a virtual machine, terminating an execution of a virtual machine, or identifying a type of physical resource for allocation to the virtual machine. In another embodiment, the hypervisor 101 executes the control operating system 105 within a virtual machine 106 created by the hypervisor 101. In still another embodiment, the control operating system 105 executes in a virtual machine 106 that is authorized to directly access physical resources on the computing device 100.

In one embodiment, the control operating system 105 executes in a virtual machine 106 that is authorized to interact with at least one guest operating system 110. In another embodiment, a guest operating system 110 communicates with the control operating system 105 via the hypervisor 101 in order to request access to a disk or a network. In still another embodiment, the guest operating system 110 and the control operating system 105 may communicate via a communication channel established by the hypervisor 101, such as, for example, via a plurality of shared memory pages made available by the hypervisor 101.

In some embodiments, the control operating system 105 includes a network back-end driver for communicating directly with networking hardware provided by the computing device 100. In one of these embodiments, the network back-end driver processes at least one virtual machine request from at least one guest operating system 110. In other embodiments, the control operating system 105 includes a block back-end driver for communicating with a storage element on the computing device 100. In one of these embodiments, the block back-end driver reads and writes data from the storage element based upon at least one request received from a guest operating system 110.

In one embodiment, the control operating system 105 includes a tools stack 104. In another embodiment, a tools stack 104 provides functionality for interacting with the hypervisor 101, communicating with other control operating systems 105 (for example, on a second computing device 100b), or managing virtual machines 106b, 106c on the computing device 100. In another embodiment, the tools stack 104 includes customized applications for providing improved management functionality to an administrator of a virtual machine farm. In some embodiments, at least one of the tools stack 104 and the control operating system 105 include a management API that provides an interface for remotely configuring and controlling virtual machines 106 running on a computing device 100. In other embodiments, the control operating system 105 communicates with the hypervisor 101 through the tools stack 104.

In one embodiment, the hypervisor 101 executes a guest operating system 110 within a virtual machine 106 created by the hypervisor 101. In another embodiment, the guest operating system 110 provides a user of the computing device 100 with access to resources within a computing environment. In still another embodiment, a resource includes a program, an application, a document, a file, a plurality of applications, a plurality of files, an executable program file, a desktop environment, a computing environment, or other resource made available to a user of the computing device 100. In yet another embodiment, the resource may be delivered to the computing device 100 via a plurality of access methods including, but not limited to, conventional installation directly on the computing device 100, delivery to the computing device 100 via a method for application streaming, delivery to the computing device 100 of output data generated by an execution of the resource on a second computing device 100′ and communicated to the computing device 100 via a presentation layer protocol, delivery to the computing device 100 of output data generated by an execution of the resource via a virtual machine executing on a second computing device 100′, or execution from a removable storage device connected to the computing device 100, such as a USB device, or via a virtual machine executing on the computing device 100 and generating output data. In some embodiments, the computing device 100 transmits output data generated by the execution of the resource to another computing device 100′.

In one embodiment, the guest operating system 110, in conjunction with the virtual machine on which it executes, forms a fully-virtualized virtual machine which is not aware that it is a virtual machine; such a machine may be referred to as a “Domain U HVM (Hardware Virtual Machine) Guest virtual machine”. In another embodiment, a fully virtualized machine includes software emulating a Basic Input/Output System (BIOS) in order to execute an operating system within the fully virtualized machine. In still another embodiment, a fully-virtualized machine may include a driver that provides functionality by communicating with the hypervisor 101; in such an embodiment, the driver is typically aware that it executes within a virtualized environment.

In another embodiment, the guest operating system 110, in conjunction with the virtual machine on which it executes, forms a paravirtualized virtual machine, which is aware that it is a virtual machine; such a machine may be referred to as a “Domain U PV Guest virtual machine”. In another embodiment, a paravirtualized machine includes additional drivers that a fully virtualized machine does not include. In still another embodiment, the paravirtualized machine includes the network back-end driver and the block back-end driver included in a utility operating system 105, as described above.

The computing device 100 may be deployed as and/or executed on any type and form of computing device, such as a computer, network device or appliance capable of communicating on any type and form of network and performing the operations described herein. FIGS. 1B and 1C depict block diagrams of a computing device 100 useful for practicing an embodiment of methods and systems described herein. As shown in FIGS. 1B and 1C, a computing device 100 includes a central processing unit 121, and a main memory unit 122. As shown in FIG. 1B, a computing device 100 may include a storage device 128, an installation device 116, a network interface 118, an I/O controller 123, display devices 124a-124n, a keyboard 126 and a pointing device 127, such as a mouse. The storage device 128 may include, without limitation, an operating system, software, and a client agent 120. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In some embodiments, the central processing unit 121 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output DRAM (EDO DRAM), Burst Extended Data Output DRAM (BEDO DRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 122 may be based on any of the above described memory chips, or any other available memory chips capable of operating as described herein. In the embodiment shown in FIG. 1B, the processor 121 communicates with main memory 122 via a system bus 150 (described in more detail below). FIG. 1 C depicts an embodiment of a computing device 100 in which the processor communicates directly with main memory 122 via a memory port 103. For example, in FIG. 1C the main memory 122 may be DRDRAM.

FIG. 1C depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. IC, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with a display device 124. FIG. 1C depicts an embodiment of a computer 100 in which the main processor 121 communicates directly with I/O device 130b via HYPERTRANSPORT, RAPIDIO, or INFINIBAND communications technology. FIG. 1C also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices include keyboards, mice, trackpads, trackballs, microphones, dials, and drawing tablets. Output devices include video displays, speakers, inkjet printers, laser printers, and dye-sublimation printers. The I/O devices may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices such as the USB Flash Drive line of devices manufactured by Twintech Industry, Inc., of Los Alamitos, Calif.

Referring again to FIG. 1B, the computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, a flash memory drive, tape drives of various formats, USB device, hard-drive or any other device suitable for installing software and programs. The computing device 100 may further comprise a storage device, such as one or more hard disk drives or redundant arrays of independent disks, for storing an operating system and other related software, and for storing application software programs such as any program related to the client agent 120. Optionally, any of the installation devices 116 could also be used as the storage device. Additionally, the operating system and the software can be run from a bootable medium, for example, a bootable CD, such as KNOPPIX, a bootable CD for GNU/Linux that is available as a GNU/Linux distribution from knoppix.net.

Furthermore, the computing device 100 may include a network interface 118 to interface to the network 104 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, CDMA, GSM, WiMax and direct asynchronous connections). In one embodiment, the computing device 100 communicates with other computing devices 100′ via any type and/or form of gateway or tunneling protocol such as Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices, such as computing devices 100a and 100b connected to the computing device 100, for example, via a network. These embodiments may include any type of software designed and constructed to use another computer's display device as a second display device 124a for the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, a Serial Attached small computer system interface bus, or a HDMI bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS MOBILE, WINDOWS XP, and WINDOWS VISTA, all of which are manufactured by Microsoft Corporation of Redmond, Wash.; MAC OS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

The computer system 100 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 100 has sufficient processor power and memory capacity to perform the operations described herein. For example, the computer system 100 may comprise a device of the IPOD family of devices manufactured by Apple Computer of Cupertino, Calif., a PLAYSTATION 2, PLAYSTATION 3, or PERSONAL PLAYSTATION PORTABLE (PSP) device manufactured by the Sony Corporation of Tokyo, Japan, a NINTENDO DS, NINTENDO GAMEBOY, NINTENDO GAMEBOY ADVANCED or NINTENDO REVOLUTION device manufactured by Nintendo Co., Ltd., of Kyoto, Japan, or an XBOX or XBOX 360 device manufactured by the Microsoft Corporation of Redmond, Wash.

In some embodiments, the computing device 100 may have different processors, operating systems, and input devices consistent with the device. For example, in one embodiment, the computing device 100 is a TREO 180, 270, 600, 650, 680, 700p, 700w, or 750 smart phone manufactured by Palm, Inc. In some of these embodiments, the TREO smart phone is operated under the control of the PalmOS operating system and includes a stylus input device as well as a five-way navigator device.

In other embodiments, the computing device 100 is a mobile device, such as a JAVA-enabled cellular telephone or personal digital assistant (PDA), such as the i55sr, i58sr, i85s, i88s, i90c, i95cl, or the im1100, all of which are manufactured by Motorola Corp. of Schaumburg, Ill., the 6035 or the 7135, manufactured by Kyocera of Kyoto, Japan, or the i300 or i330, manufactured by Samsung Electronics Co., Ltd., of Seoul, Korea. In some embodiments, the computing device 100 is a mobile device manufactured by Nokia of Finland, or by Sony Ericsson Mobile Communications AB of Lund, Sweden.

In still other embodiments, the computing device 100 is a Blackberry handheld or smart phone, such as the devices manufactured by Research In Motion Limited, including the Blackberry 7100 series, 8700 series, 7700 series, 7200 series, the Blackberry 7520, or the Blackberry Pearl 8100. In yet other embodiments, the computing device 100 is a smart phone, Pocket PC, Pocket PC Phone, or other handheld mobile device supporting Microsoft Windows Mobile Software. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

In some embodiments, the computing device 100 is a digital audio player. In one of these embodiments, the computing device 100 is a digital audio player such as the Apple IPOD, IPOD Touch, IPOD NANO, and IPOD SHUFFLE lines of devices, manufactured by Apple Computer of Cupertino, Calif. In another of these embodiments, the digital audio player may function as both a portable media player and as a mass storage device. In other embodiments, the computing device 100 is a digital audio player such as the DigitalAudioPlayer Select MP3 players, manufactured by Samsung Electronics America, of Ridgefield Park, N.J., or the Motorola m500 or m25 Digital Audio Players, manufactured by Motorola Inc. of Schaumburg, Ill. In still other embodiments, the computing device 100 is a portable media player, such as the ZEN VISION W, the ZEN VISION series, the ZEN PORTABLE MEDIA CENTER devices, or the Digital MP3 line of MP3 players, manufactured by Creative Technologies Ltd. In yet other embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 includes a combination of devices, such as a mobile phone combined with a digital audio player or portable media player. In one of these embodiments, the computing device 100 is a smartphone, for example, an iPhone manufactured by Apple Computer, or a Blackberry device, manufactured by Research In Motion Limited. In yet another embodiment, the computing device 100 is a laptop or desktop computer equipped with a web browser and a microphone and speaker system, such as a telephony headset. In these embodiments, the computing devices 100 are web-enabled and can receive and initiate phone calls. In other embodiments, the communications device 100 is a Motorola RAZR or Motorola ROKR line of combination digital audio players and mobile phones.

A computing device 100 may be a file server, application server, web server, proxy server, appliance, network appliance, gateway, application gateway, gateway server, virtualization server, deployment server, SSL VPN server, or firewall. In some embodiments, a computing device 100 provides a remote authentication dial-in user service, and is referred to as a RADIUS server. In other embodiments, a computing device 100 may have the capacity to function as either an application server or as a master application server. In still other embodiments, a computing device 100 is a blade server.

In one embodiment, a computing device 100 may include an Active Directory. The computing device 100 may be an application acceleration appliance. For embodiments in which the computing device 100 is an application acceleration appliance, the computing device 100 may provide functionality including firewall functionality, application firewall functionality, or load balancing functionality. In some embodiments, the computing device 100 comprises an appliance such as one of the line of appliances manufactured by the Citrix Application Networking Group, of San Jose, Calif., or Silver Peak Systems, Inc., of Mountain View, Calif., or of Riverbed Technology, Inc., of San Francisco, Calif., or of F5 Networks, Inc., of Seattle, Wash., or of Juniper Networks, Inc., of Sunnyvale, Calif.

In other embodiments, a computing device 100 may be referred to as a client node, a client machine, an endpoint node, or an endpoint. In some embodiments, a client 100 has the capacity to function as both a client node seeking access to resources provided by a server and as a server node providing access to hosted resources for other clients.

In some embodiments, a first, client computing device 100a communicates with a second, server computing device 100b. In one embodiment, the client communicates with one of the computing devices 100 in a farm 38. Over the network, the client can, for example, request execution of various applications hosted by the computing devices 100 in the farm 38 and receive output data of the results of the application execution for display. In one embodiment, the client executes a program neighborhood application to communicate with a computing device 100 in a farm 38.

A computing device 100 may execute, operate or otherwise provide an application, which can be any type and/or form of software, program, or executable instructions such as any type and/or form of web browser, web-based client, client-server application, a thin-client computing client, an ActiveX control, or a Java applet, or any other type and/or form of executable instructions capable of executing on the computing device 100. In some embodiments, the application may be a server-based or a remote-based application executed on behalf of a user of a first computing device by a second computing device. In other embodiments, the second computing device may display output data to the first, client computing device using any thin-client or remote-display protocol, such as the Independent Computing Architecture (ICA) protocol manufactured by Citrix Systems, Inc. of Ft. Lauderdale, Fla.; the Remote Desktop Protocol (RDP) manufactured by the Microsoft Corporation of Redmond, Wash.; the X11 protocol; the Virtual Network Computing (VNC) protocol, manufactured by AT&T Bell Labs; the SPICE protocol, manufactured by Qumranet, Inc., of Sunnyvale, Calif., USA, and of Raanana, Israel; the Net2Display protocol, manufactured by VESA, of Milpitas, Calif.; the PC-over-IP protocol, manufactured by Teradici Corporation, of Burnaby, B.C.; the TCX protocol, manufactured by Wyse Technology, Inc., of San Jose, Calif.; the THINC protocol developed by Columbia University in the City of New York, of New York, N.Y.; or the Virtual-D protocols manufactured by Desktone, Inc., of Chelmsford, Mass. The application can use any type of protocol and it can be, for example, an HTTP client, an FTP client, an Oscar client, or a Telnet client. In other embodiments, the application comprises any type of software related to voice over internet protocol (VoIP) communications, such as a soft IP telephone. In further embodiments, the application comprises any application related to real-time data communications, such as applications for streaming video and/or audio.

In some embodiments, a first computing device 100a executes an application on behalf of a user of a client computing device 100b. In other embodiments, a computing device 100a executes a virtual machine, which provides an execution session within which applications execute on behalf of a user or a client computing devices 100b. In one of these embodiments, the execution session is a hosted desktop session. In another of these embodiments, the computing device 100 executes a terminal services session. The terminal services session may provide a hosted desktop environment. In still another of these embodiments, the execution session provides access to a computing environment, which may comprise one or more of: an application, a plurality of applications, a desktop application, and a desktop session in which one or more applications may execute.

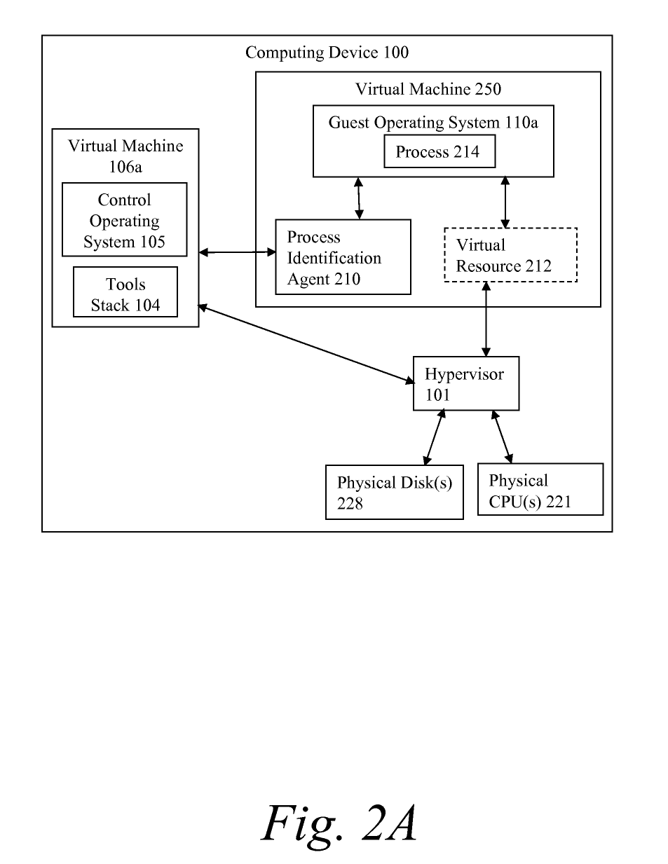

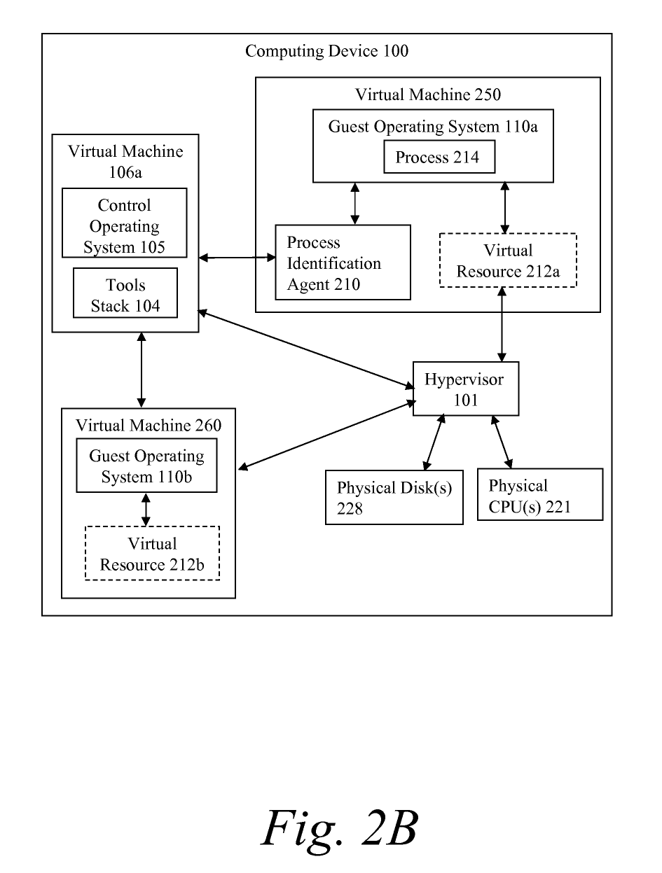

Referring now to FIG. 2A, a block diagram depicts one embodiment of a system for optimizing configuration of a virtual machine running at least one process. In brief overview, the system includes a computing device 100, a virtual machine 250, a hypervisor 101, and a process identification agent 210. The computing device 100 includes at least one physical hardware resource, such as, for example, a physical processor 221. The hypervisor 101 executes on the computing device 100. The virtual machine 250 executes on a computing device 100 and includes at least one guest operating system 110 and at least one virtual resource 212. The at least one virtual resource 212 has a configuration parameter. The process identification agent 210, executing within the virtual machine 250 identifies a name of at least one process 214 currently executing on the virtual machine 250. The hypervisor 101 alters, in response to receiving the identified name from the process identification agent 210, at least one value of the configuration parameter.

Referring now to FIG. 2A, and in greater detail, the virtual machine 250 includes at least one virtual resource 212. In one embodiment, the at least one virtual resource 212 is a virtual processor 132, as described above in connection with FIG. 1A. In another embodiment, the at least one virtual resource 212 is a virtual disk 142, as described above in connection with FIG. 1A. In still another embodiment, the virtual resource is a virtual network device. In another embodiment, the virtual resource is virtual memory. In still even another embodiment, the hypervisor 101 creates the at least one virtual resource 212. In yet another embodiment, the hypervisor 101 loads a virtual machine image to execute the virtual machine 250 and the virtual machine image defines at least one virtual resource, which the hypervisor 101 instantiates.

The at least one virtual resource 212 has a configuration parameter. In one embodiment, for example, a configuration parameter identifies a physical resource to which the virtual resource 212 has access and a value of the configuration parameter specifies how much access to the physical resource the virtual resource 212 has been allocated.

The process identification agent 210 executes within the virtual machine 250 and identifies a name of at least one process currently executing on the virtual machine 250. In another embodiment, the process identification agent 210 executes in the virtualization layer on the computing device 100. In still another embodiment, the process identification agent 210 executes in the hypervisor layer on the computing device 100. In some embodiments, the process identification agent 210 includes a transceiver. In one of these embodiments, the transceiver in the process identification agent 210 transmits the identified name to the hypervisor 101. In other embodiments, the process identification agent 210 includes functionality for querying the guest operating system 110 to identify at least one process currently executing on the virtual machine 250. In one of these embodiments, for example, the process identification agent 210 accesses an applications programming interface to query a shell component of the guest operating system 110.

In one embodiment, the process identification agent 210 is a component within the guest operating system 110. In another embodiment, a user installs the process identification agent 210 into the guest operating system 110 during an installation or initialization process during an initial execution of the guest operating system 110; for example, the user may receive an option to install a plurality of management tools including the process identification agent 210 when the user initially executes the guest operating system 110. In still another embodiment, the process identification agent 210 is referred to as a “guest agent”.

The hypervisor 101 alters a value of the configuration parameter, in response to receiving the identified name from the process identification agent 210. In one embodiment, the hypervisor 101 receives the identified name indirectly, via a control operating system 105 in communication with both the process identification agent 210 and the hypervisor 101. In another embodiment, the altered value specifies an amount of physical processor time allocated to the virtual machine. In still another embodiment, the altered value specifies an amount of random access memory (RAM) allocated to a page table associated with the virtual machine. In yet another embodiment, the altered value specifies an amount of physical random access memory (RAM) allocated to the virtual machine. In some embodiments, the hypervisor allocates access, by the at least one virtual resource, to the at least one physical resource provided by the computing device 100, responsive to a value of the specified configuration parameter. In other embodiments, the hypervisor 101 alters a value of the configuration parameter, in response to receiving from at least one of the process identification agent 210 and the control operating system 105, an instruction to make the alteration.

Referring now to FIG. 2B, a block diagram depicts one embodiment of a system for optimizing configuration of a plurality of virtual machines. In brief overview, the system includes a computing device 100, a first virtual machine 250, a second virtual machine 260, a hypervisor 101, and a process identification agent 210. As depicted in FIG. 2B, the process identification agent 210 executing on the first virtual machine 250 is in communication with a control operating system 105, which is in communication with the hypervisor 101. The process identification agent 210 identifies a name of at least one process currently executing on the virtual machine 250. The process identification agent 210 includes a transceiver transmitting, to the control operating system 105, the identified name. The control operating system 105 identifies an alteration to be made to a value of a configuration parameter of at least one virtual resource in a second virtual machine 260. The control operating system 105 includes a transmitter sending, to the hypervisor 101, an instruction to alter the identified value of the at least one resource in the second virtual machine 260. In one embodiment, the hypervisor alters a value of a configuration parameter of at least one virtual resource in the second virtual machine, responsive to receiving, from at least one of the process identification agent 210 and the control operating system 105, an instruction to alter the value. In another embodiment, the hypervisor alters a value of a configuration parameter of at least one virtual resource in the second virtual machine, responsive to receiving, from at least one of the process identification agent 210 and the control operating system 105, the identified name.

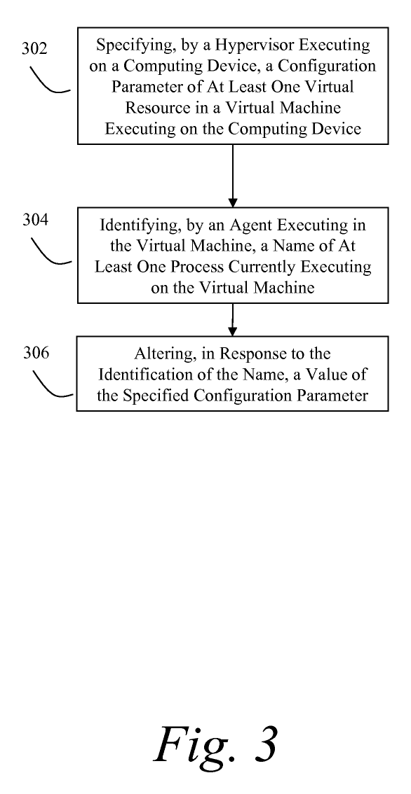

Referring now to FIG. 3, a flow diagram depicts one embodiment of a method for optimizing configuration of a virtual machine running at least one process. In brief overview, the method includes specifying, by a hypervisor executing on a computing device, a configuration parameter of at least one virtual resource in a virtual machine executing on the computing device (302). The method includes identifying, by an agent executing in the virtual machine, a name of at least one process currently executing on the virtual machine (304). The method includes altering, in response to the identification of the name, a value of the specified configuration parameter (306). In some embodiments, a computer readable medium is provided having instructions thereon that when executed provide for optimizing configuration of a virtual machine running at least one process.

Referring now to FIG. 3, and in greater detail, a hypervisor specifies a configuration parameter of at least one virtual resource in a virtual machine executing on the computing device (302). In one embodiment, the hypervisor 101 specifies a value of the configuration parameter of the at least one virtual resource 212. In some embodiments, the hypervisor 101 specifies a configuration parameter of the at least one virtual resource 212 in the virtual machine 250 during a virtual machine initialization process. In one of these embodiments, for example, the hypervisor 101 may generate the virtual machine 250 by creating an instance of a virtual machine image, the virtual machine image identifying at least one virtual resource 212 to be included in the virtual machine 250 and specifying a configuration parameter of the at least one virtual resource 212. In another of these embodiments, the hypervisor 101 may access a configuration specification to determine a value of the configuration parameter. In other embodiments, the hypervisor 101 accesses a configuration mapping that associates an identification of at least one resource with a value for a configuration parameter of the at least one resource. In one of these embodiments, for example, the hypervisor 101 may access a configuration mapping that indicates that the virtual machine should include a virtual processor 132 having access to a certain amount of time on a physical processor 221 (the configuration parameter) and specify the amount of time from the physical processor 221 (the value of the configuration parameter). In further embodiments, the hypervisor 101 allocates access, by the at least one virtual resource 212, to the at least one physical resource provided by the computing device 100, responsive to the value of the specified configuration parameter.

An agent executing in the virtual machine identifies a name of at least one process currently executing on the virtual machine (304). In one embodiment, the agent transmits the identified name to a control operating system 105. In some embodiments, a process identification agent 210 identifies the name of the at least one process executing on the virtual machine 250. In one of these embodiments, the process identification agent 210 queries a shell component of the guest operating system 110 to determine the name of the process 214 executing on the guest operating system 110 within the virtual machine 250. In another of these embodiments, the process identification agent 210 transmits the identified name of the process to the control operating system 105. In still another of these embodiments, the process identification agent 210 transmits the identified name of the process to the tools stack 104. In other embodiments, the process identification agent 210 accesses an applications programming interface provided by the guest operating system 110 to retrieve an enumeration of processes executing on the virtual machine 250. In further embodiments, the process identification agent 210 transmits the identified name to the hypervisor 101.

In some embodiments, the process identification agent 210 communicates with the control operating system 105 via a shared memory page communication channel established by the hypervisor 101. In other embodiments, the process identification agent 210 communicates with the control operating system 105 via a network stack on the computing device 100. In still other embodiments, the process identification agent 210 communicates with the control operating system 105 via modifications to a shared ring buffer or other data structure stored on the computing device 100.

In one embodiment, the control operating system 105 determines that a value of the specified configuration parameter should change, based upon the identified name of the at least one process currently executing on the virtual machine. In another embodiment, for example, the control operating system 105 determines that the process identification agent 210 has identified the name of a computationally-intense process 214 that the virtual machine 250 has begun executing and that a virtual processor 132 on the virtual machine 250 is currently allocated insufficient access to a physical processor 221 to execute the process 214; the control operating system 105 determines that the value of the specified configuration parameter—the quantity of time from the physical processor allocated to the virtual processor, for example—should be altered. In still another embodiment, by increasing the value of the specified configuration parameter, the control operating system 105 may improve the performance of the process 214 within the virtual machine 250. In yet another embodiment, the control operating system 105 transmits an instruction to the hypervisor 101 to alter the value of the specified configuration parameter.

In one embodiment, the control operating system 105 accesses a configuration file to determine whether to instruct the hypervisor 101 to alter the value of the specified configuration parameter responsive to the identified name of the process 214. In another embodiment, the control operating system 105 accesses a mapping between at least one process and a value for at least one specified configuration parameter. In still another embodiment, for example, the mapping may identify a plurality of known processes and a recommended value for each of a plurality of configuration parameters of a virtual resource on a virtual machine; the recommended value may be specified to optimize a particular characteristic of the virtual machine, such as, for example, mobility, performance, or reliability. For example, a configuration file may identify the following mappings:

| Identified | | | |
|---|---|---|---|
| Process | Virtual Resource | Configuration Parameter | Value |
| ADOBE | Virtual Memory | GB of Physical Memory | 2 GB |
| PHOTOSHOP | | allocated to Virtual Machine | |

In the example above, if the control operating system 105 receives, from the process identification agent 210, an identification that the virtual machine 250 has begun executing ADOBE PHOTOSHOP, the control operating system 105 may query the hypervisor 101 to determine the value of the configuration parameter that specifies how much virtual memory the hypervisor 101 initially allocated to the virtual machine 250. If the value of the configuration parameter is less than 2 GB, then the control operating system 105 may direct the hypervisor 101 to alter the value, increasing the amount of virtual memory to 2 GB. In some embodiments, the control operating system 105 may query the hypervisor 101 as to the value of a configuration parameter of a virtual resource in a virtual machine 260. In one of these embodiments, the control operating system 105 may evaluate an enumeration of processes executing on the virtual machine 260 and instruct the hypervisor 101 to de-allocate resources from the virtual machine 260, in order to make resources available for allocation to the virtual machine 250. In another of these embodiments, for example, and referring again to the table above, should the control operating system 105 determine that the value of the configuration parameter identifying an amount of virtual memory available to the virtual machine 250 is too low for the virtual machine 250 to execute ADOBE PHOTOSHOP, while also determining that the virtual machine 260 does not execute any processes utilizing all of its allocated virtual memory, the control operating system 105 may direct the hypervisor 101 to reduce an amount of virtual memory allocated to the virtual machine 260 and increase an amount of virtual memory allocated to the virtual machine 250.

In one embodiment, and as another example, when the process identification agent 210 identifies that a CITRIX XENAPP process is executing within the virtual machine 250, the tools stack 104 within the control operating system 105 dynamically reconfigures a “shadow memory multiplier” configuration parameter, increasing the value by a factor of four above the default value, which instructs the hypervisor to increase an amount of physical RAM allocated to managing at least one page table associated with the virtual machine 250.

In some embodiments, the control operating system 105 may request a configuration file including a mapping between processes and values for configuration parameters from a second control operating system 105b. In other embodiments, the system includes a master computing device 100b that executes a control operating system 105b, which may provide a centralized location from which other control operating systems may retrieve mappings between known processes and best-known configurations. In still other embodiments, the system includes a storage element such as, without limitation, a network storage device, a network-accessible database, or other storage element, that provides a centralized location from which other control operating systems may retrieve mappings between known processes and best-known configurations. In further embodiments, the control operating system 105a may transmit to a second control operating system 105b a copy of a mapping established by the control operating system 105a.

In response to the identification of the name, a value of the specified configuration parameter is altered (306). In one embodiment, the hypervisor 101 alters the value of the specified configuration parameter. In another embodiment, the hypervisor 101 alters the value responsive to an instruction from the control operating system 105.

In one embodiment, a property specifying an amount of physical processor time allocated to the virtual machine is altered. In another embodiment, a property specifying an amount of random access memory (RAM) allocated to a page table associated with the virtual machine is altered. In still another embodiment, a property specifying an amount of physical random access memory (RAM) allocated to the virtual machine is altered.

In one embodiment, the hypervisor 101 alters a number of processes allocated to the virtual machine 250. In another embodiment, the hypervisor 101 alters a number of flags identifying functionality provided to the virtual machine 250; for example, particular processes might benefit from access to functionality identified by particular processor flags or not require others. In still another embodiment, the hypervisor 101 alters a method for using, by the virtual machine 250, virtual memory; for example, the hypervisor 101 may alter an amount of memory or a method for allocation of memory used to maintain composition of guest page tables and hypervisor-related data. In some embodiments, the hypervisor 101 alters a value of a configuration parameter of at least one virtual resource in a second virtual machine. In one of these embodiments, the hypervisors makes the alteration, responsive to receiving, from at least one of the agent and the control operating system, an instruction to make the alteration. In another of these embodiments, the hypervisors makes the alteration, responsive to receiving, from at least one of the agent and the control operating system, the identified name. In still another of these embodiments, the hypervisors alters a value of a configuration parameter of at least one virtual resource in a second virtual machine provided by a second computing device 100b.

In one embodiment, the methods and systems described herein allow dynamic re-allocation of physical resources to virtual resources based upon a type of process executed by a virtual machine. In another embodiment, by identifying a type of process that a virtual machine begins executing, a control operating system can evaluate the requirements of the virtual machine and ensure that the current allocation of physical resources provided to virtual resources of the virtual machine is appropriate given the processing needs of the virtual machine. In still another embodiment, the methods and systems described herein provide enhanced functionality and efficiency by dynamically evaluating the needs of each of a plurality of virtual machines and de-allocating resources from virtual machines that underutilize their allocated access while increasing allocations to virtual machines that execute processors requiring increased access to resources.

It should be understood that the systems described above may provide multiple ones of any or each of those components and these components may be provided on either a standalone machine or, in some embodiments, on multiple machines in a distributed system. In addition, the systems and methods described above may be provided as one or more computer-readable programs embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, or in any byte code language such as JAVA. The software programs may be stored on or in one or more articles of manufacture as object code.

Having described certain embodiments of methods and systems for optimizing configuration of a virtual machine running at least one process, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for optimizing configuration of a virtual machine running at least one process, the method comprising:
specifying, by a hypervisor executing on a computing device, a configuration parameter of at least one virtual resource in a virtual machine executing on the computing device;
identifying, by an agent executing in the virtual machine, a name of at least one process currently executing on the virtual machine; and
altering, in response to the identification of the name, a value of the specified configuration parameter.

2. The method of claim 1 further comprising allocating, by the hypervisor, access by the at least one virtual resource to at least one physical resource provided by the computing device, responsive to the value of the specified configuration parameter.

3. The method of claim 1 further comprising transmitting, by the agent, to the hypervisor, the identified name.

4. The method of claim 1 further comprising altering, by the hypervisor, a value of a configuration parameter of at least one virtual resource in a second virtual machine, responsive to receiving, from the agent, the identified name.

5. The method of claim 1, wherein altering further comprises altering a value specifying an amount of physical processor time allocated to the virtual machine.

6. The method of claim 1, wherein altering further comprises altering a value specifying an amount of random access memory (RAM) allocated to a page table associated with the virtual machine.

7. The method of claim 1, wherein altering further comprises altering a value specifying an amount of physical random access memory (RAM) allocated to the virtual machine.

8. A computer readable medium having instructions thereon that when executed provide a method for optimizing configuration of a virtual machine running at least one process, the computer readable media comprising:
instructions to specify, by a hypervisor executing on a computing device, a configuration parameter of at least one virtual resource in a virtual machine executing on the computing device;
instructions to identify, by an agent executing in the virtual machine, a name of at least one process currently executing on the virtual machine; and
instructions to alter, in response to the identification of the name, a value of the specified configuration parameter.

9. The computer readable media of claim 8 further comprising instructions to allocate, by the hypervisor, access by the at least one virtual resource to at least one physical resource provided by the computing device, responsive to the value of the specified configuration parameter.

10. The computer readable media of claim 8 further comprising instructions to transmit, by the agent, to the hypervisor, the identified name.

11. The computer readable media of claim 8 further comprising instructions to alter, by the hypervisor, a value of a configuration parameter of at least one virtual resource in a second virtual machine, responsive to receiving, from the agent, the identified name.

12. The computer readable media of claim 8 further comprising instructions to alter a value specifying an amount of physical processor time allocated to the virtual machine.

13. The computer readable media of claim 8 further comprising instructions to alter a value specifying an amount of random access memory (RAM) allocated a page table associated with the virtual machine.

14. The computer readable media of claim 8 further comprising instructions to alter a value specifying an amount of physical random access memory (RAM) allocated to the virtual machine.

15. A system for optimizing configuration of a virtual machine running at least one process comprising:
at least one virtual resource in a virtual machine executing on a computing device, the at least one virtual resource having a configuration parameter;
an agent executing within the virtual machine and identifying a name of at least one process currently executing on the virtual machine; and
a hypervisor altering, in response to receiving the identified name from the agent, a value of the configuration parameter.

16. The system of claim 15, wherein the at least one virtual resource further comprises a virtual processor.

17. The system of claim 15, wherein the at least one virtual resource further comprises virtual memory.

18. The system of claim 15, wherein the agent further comprises a transceiver transmitting, to the hypervisor, the identified name.

19. The system of claim 15, wherein the hypervisor further comprises means for allocating access by the at least one virtual resource to at least one physical resource provided by the computing device, responsive to a value of the specified configuration parameter.

20. The system of claim 15, wherein the hypervisor further comprises means for altering a value of a configuration parameter of at least one virtual resource in a second virtual machine, responsive to receiving, from the agent, the identified name.

21. The system of claim 15, wherein the hypervisor further comprises means for altering a value specifying an amount of physical processor time allocated to the virtual machine.

22. The system of claim 15, wherein the hypervisor further comprises means for altering a value specifying an amount of random access memory (RAM) allocated to a page table associated with the virtual machine.

23. The system of claim 15, wherein the hypervisor further comprises means for altering a value specifying an amount of physical random access memory (RAM) allocated to the virtual machine.
